(19) United States
(12) Patent Application Publication
(10) Pub. No.: US 2009/0122142 A1
(43) Pub. Date: May 14, 2009

(54) Distributed mobile surveillance system and method

(76) Inventor: Bruce Douglas Shapley, Holland, PA (US)

Correspondence Address: T/BD ASSOCIATES, INC., 1225 WOODS ROAD, SOUTHAMPTON, PA, 18966, US

(21) Appl. No.: 12/290,764

(22) Filed: Nov. 3, 2008

Related U.S. Application Data
(60) Provisional application No. 61/002,630, filed on Nov. 9, 2007.

(51) Int. Cl. H04N 7/18

(52) U.S. Cl. 348/148; 348/E07.085

(57) ABSTRACT

A method of gathering evidence of a crime or terrorist incident comprises surveilling an area with one or more cameras and, optionally, one or more audio pick-ups (e.g., microphones) installed in or on a large number of automobiles, trucks, buses, and other vehicles. Evidence of an incident may be collected and processed for use by law-enforcement officials in identifying perpetrators and may be used before a grand jury or court-of-law.

This application claims benefit of U.S. Provisional Patent Application Ser. No. 61/002,630 filed on Nov. 9, 2007.

### TECHNICAL FIELD

This invention generally relates to surveillance, and in particular, to the use of a distributed mobile surveillance system.

### BACKGROUND

In recent years, serious crime and acts of terrorism have become daily fixtures on the front pages of many of the world's major newspapers and on television news reports. The persistence of these stories, and the underlying acts, has created a sense of vulnerability and raised the anxiety level of the general public as these crimes go unsolved, and the perpetrators unpunished.

Gathering evidence from before, during and after a crime or act of terrorism is all too often a complex, painstaking, and frustrating task. Physical evidence may be lacking or insufficient to identify a perpetrator, or may not have sufficient veracity to hold up in a court-of-law. Often, there are no eye-witnesses to an incident, or no witnesses who are willing to provide information or testimony. Even when a willing witness can be identified, the accuracy and reliability of their testimony may be questionable.

Recently, surveillance cameras have been installed in a limited number of fixed locations, especially in larger cities and in high crime areas. These cameras may provide some evidence of a crime, but the location of such cameras may be known to criminals or terrorists. And because of the limited number of camera locations, the probability of capturing on camera a particular incident is low.

### SUMMARY

In one embodiment, a system and method of surveilling an area may include one or more cameras and, optionally, one or more audio pick-ups (e.g., microphones) installed in or on a large number of automobiles, trucks, buses, and other vehicles. For example, the cameras, microphones and associated equipment may be installed on every new car manufactured after a certain date, or on every municipal vehicle or on every vehicle used for public transportation. In general, the more vehicles on which cameras, microphones and associated equipment are installed, the more effective will be their use in providing evidence in the event of a crime or act of terrorism.

Each of the cameras has a view of the area in front of, behind, or beside the vehicle on which it is installed. Each camera's output (video or sequence of still images), and the output from each microphone, may be fed into a recording/storage apparatus. The recording apparatus may be any type of magnetic, optical, or semiconductor memory, or a combination of two or more types of storage media. Along with the camera and microphone output, other ancillary data may be recorded, including, but not limited to, vehicle identification, date, time-of-day, vehicle location, and vehicle orientation, along with any other useful information regarding the vehicle and surrounding conditions.

Recorded information from vehicle cameras, microphones and ancillary data may be accessed either directly (by removing the recording/storage apparatus) or by transmitting the data through a wired or wireless communications medium. The data may be accessed on a periodic basis or only in the event of a criminal or terrorist incident. In one embodiment, the data storage units may be connected into a wireless wide area network or cellular data network to allow rapid and timely access to recorded data. In one embodiment, a central data aggregation facility may access any of the mobile units to collect camera and ancillary data. The central data aggregation facility may be located at a law-enforcement facility, or may be run by a private service provider. In the event of a criminal or terrorist incident, the central data aggregation facility may be provided with the location, date and time of the incident, and, using this information, selectively access only those mobile units that were located in the general proximity near the time of the incident. The data collected in this way may be examined by law-enforcement agents for evidence useful in the investigation of the incident. And, because the camera data is accompanied by a complete set of identifying information and meets strict chain-of-custody requirements, it may be used as evidence in a court-of-law.

These and other features and objects of the invention will be more fully understood from the following detailed description of the embodiments which should be read in light of the accompanying drawings.

In this respect, before explaining at least one embodiment of the invention in detail, it is to be understood that the invention is not limited in its application to the details of construction and to the arrangements of the components set forth in the description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be used as a basis for designing other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 illustrates a simplified diagram of a crime scene and an exemplary distributed mobile surveillance system;

FIG. 2 illustrates a simplified block diagram of an embodiment of an on-vehicle acquisition, storage and communication system;

FIG. 3 illustrates a simplified functional block diagram of a central collection point;

FIG. 4 illustrates a simplified flow diagram for a process of using a distributed surveillance system; and

FIG. 5 illustrates a simplified flow diagram for a process carried out in an on-vehicle acquisition, storage and communication system.

### DETAILED DESCRIPTION

In describing an embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

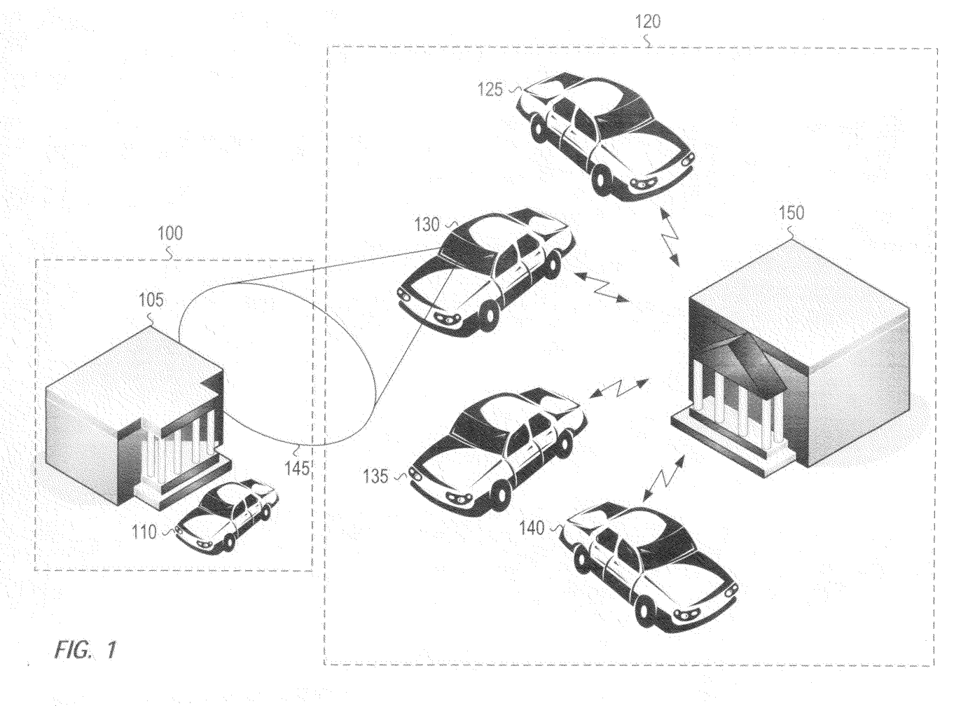

FIG. 1 shows a simplified diagram of a crime scene and an exemplary distributed mobile surveillance system. In FIG. 1, the scene of a crime or terrorist incident 100 may include a building structure 105 (a bank, for example), one or more crime vehicles 110 and one or more perpetrators (not shown). The distributed mobile surveillance system 120 may comprise a plurality of surveillance vehicles (125-140) and a central collection point 150. Each of the surveillance vehicles 125-140 includes an on-vehicle acquisition, storage and communication system (described in detail below). One or more of the surveillance vehicles may have, at or near the time of a crime or terrorist incident, a view of the scene of the incident. In the simplified example shown in FIG. 1, vehicle 130 has a view 145 of the incident. Surveillance vehicles 125-140 may be regular passenger cars (for example, every new car manufactured may include surveillance equipment) or municipal vehicles or vehicles used for public transportation. A key principle is that the greater the number of surveillance vehicles available in an area, the more effective will be their use in providing evidence in the event of a crime or act of terrorism. In addition, a large number of surveillance vehicles may provide a greater deterrence to criminal or terrorist acts.

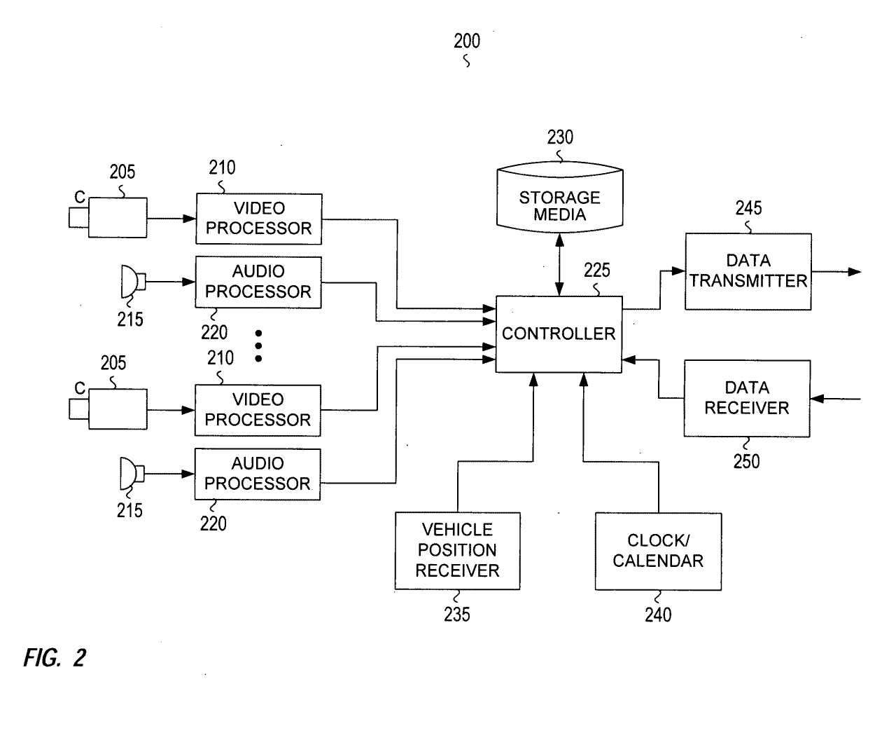

FIG. 2 illustrates a simplified block diagram of an embodiment of an on-vehicle acquisition, storage and communication system 200. In FIG. 2, one or more cameras 205 may be mounted in or on a surveillance vehicle (shown as 125-140 in FIG. 1). Each camera 205 may operate to acquire either continuous video or a series of still images. Each of the cameras 205 has a view of the area in front of, behind, or beside the surveillance vehicle on which it is installed. In the example shown in FIG. 1, one of the cameras mounted in or on surveillance vehicle 130 has a view of the area front of surveillance vehicle 130. Referring again to FIG. 2, the output of each camera 205 is fed into video processor 210, where it is converted to a form that is readily amenable to storage and transmission. In one embodiment, video processor 210 converts the camera signal to digital form and compresses the resultant digital data using one or more well-known methods for compressing video or still image data. This includes, for example, JPEG, JPEG2000, MPEG-1, MPEG-2, MPEG-4, WMV, VC-1, or any other similar means.

In one embodiment, audio input may also be acquired from one or more microphones 215 mounted in or on the surveillance vehicle. The one or more microphones may be directional or omnidirectional. The output from each microphone 215 is fed into audio processor 220, where it is converted to a form that is readily amenable to storage and transmission. In one embodiment, audio processor 220 converts the microphone signal to digital form and compresses the resultant digital data using one or more well-known methods for compressing audio information. This includes, for example, MPEG-1 Audio Level 3 (often referred to as MP3), AAC, WMA, or any other similar means.

The output of each of the video processors 210 and audio processors 220 is fed into controller 225. Controller 225 manages the process of storing the incoming camera and audio data using storage media 230. Storage media 230 may be any of the numerous types of well-known digital storage components, including magnetic disk or tape drives, semiconductor memory (Flash, DRAM, SRAM, etc.), or any type of optical media (CD, DVD, etc.). Storage media 230 may also include multiple types of components, organized, for example, into a storage hierarchy. In one embodiment, a relatively small amount of semiconductor storage may be used to store several seconds or minutes of incoming data. When the semiconductor storage reaches its capacity, the data may be stored on a much larger capacity magnetic or optical drive. The total capacity of storage media 230 may be as short as several hours or may be much longer (several days, for example). In one embodiment, one or more components of storage media 230 may be removable to enable direct access to the data stored thereon.

Controller 225 also receives inputs from vehicle position receiver 235 and clock/calendar 240. Vehicle position receiver 235 may determine the instantaneous position and orientation of the vehicle using one or more of the many well-known methods, including GPS (Global Positioning System), WAAS (Wide Area Augmentation System), dead-reckoning, map matching, magnetic compass, etc. Clock/calendar 240 may continuously generates the local current time and date. Vehicle position receiver 235 and clock/calendar 240 may be part of an on-vehicle entertainment and/or navigation system, for example, or may be individual or combined stand-alone components. Controller 225 uses the inputs from vehicle position receiver 235 and clock/calendar 240 to label segments of camera and audio data. Labeled segments of camera and audio data may be as short as individual video frames (typically 0.033-0.040 second) or may be as long one to five seconds. Each segment is labeled with the time and date that the segment was acquired and the exact position and orientation of the vehicle at the time the segment was captured. The additional data (time, date, position, orientation) may be stored along with the camera and audio data, or may be stored in a separate portion of the storage media 230. If stored separately, the additional data may include a link to the location of the associated segment of camera and audio data.

Controller 225 may also interact with data transmitter 245 and data receiver 250 to exchange data with a central collection point (shown as 150 in FIG. 1). Data transmitter 245 and data receiver 250 may connect with the central collection point using either a wired or a wireless connection. If data transmitter 245 and data receiver 250 connects with the central collection point using a wired connection, then this connection is made only when the vehicle is parked at a designated location where a temporary wired connection can be made. In one embodiment, data transmitter 245 and data receiver 250 may connect with the central collection point using one of the many well-known wireless wide-area, metropolitan area or cellular network technologies, including EV-DO, WiMAX, WiFi, GPRS, EDGE, or any other similar wireless communications system. Data transmitter 245 is used to transmit the data stored on storage media 230. The data may be transmitted continuously, periodically, or only when requested. Data receiver 250 may be used by the central collection point to control or throttle the transmission of data from data transmitter 245. Data receiver 250 may also be used to receive requests from the central collection point for specific data stored on storage media 230.

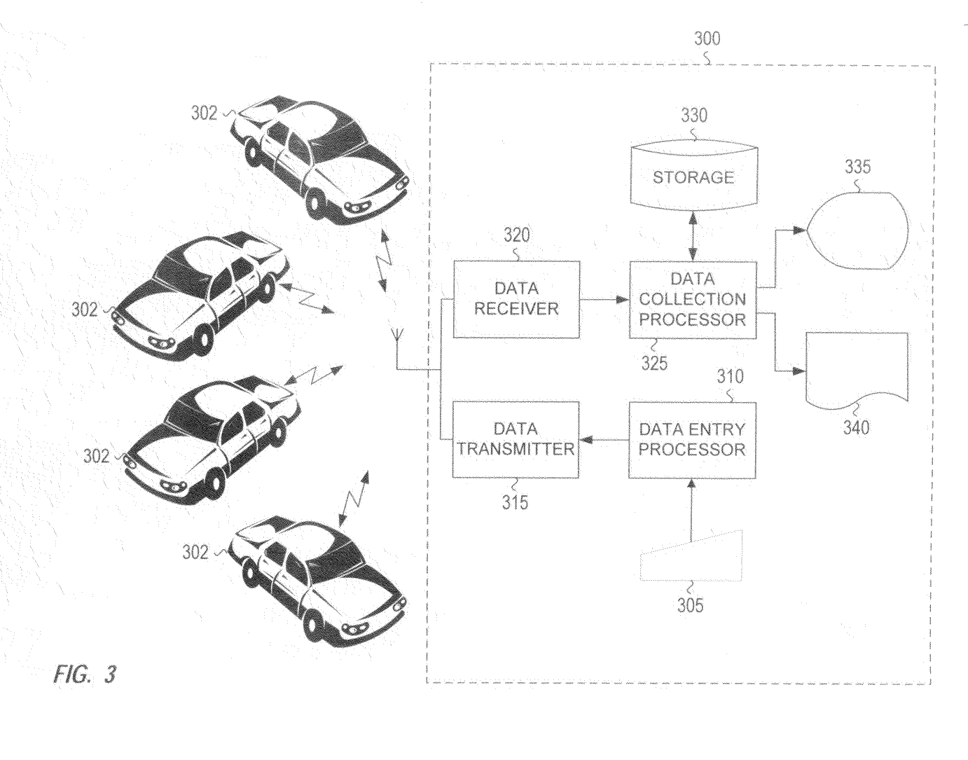

FIG. 3 illustrates a simplified functional block diagram of a central collection point 300. In FIG. 3, surveillance vehicles 302 (corresponding to surveillance vehicles 125-140 in FIG. 1) communicate with central collection point 300. In one embodiment, in central collection point 300, data entry console 305 may be used to enter the details of a crime or terrorist incident. The details may include, but are not limited to, the location, date and time of the incident, and a range of locations and times considered to be important in the process of gathering evidence. Data entry processor 310 receives the input from data entry console 305 and prepares the information for transmission to the surveillance vehicles 302. Data transmitter 315 receives the prepared information from data entry processor 310 and may broadcast the information to one or more of the surveillance vehicles 302.

Referring again to FIG. 3, data receiver 320 receives data from one or more surveillance vehicles 302. The received data is fed into data collection processor 325. Data collection processor 325 consolidates the data received from each of the surveillance vehicles 302, using storage 330 to create a consolidated collection of evidence gathered regarding the incident. Once data collection processor 325 has received and consolidated all of the data regarding the incident, it may prepare the data for presentation on visual display 335 or may prepare a hard-copy (paper, CD-ROM, DVD, etc.) on hard-copy unit 340. A detective or other law-enforcement officer may review the visual display 335 or material from hard-copy unit 340 for evidence that may be useful in identifying or locating a perpetrator or for gathering evidence for use before a grand jury or court-of-law.

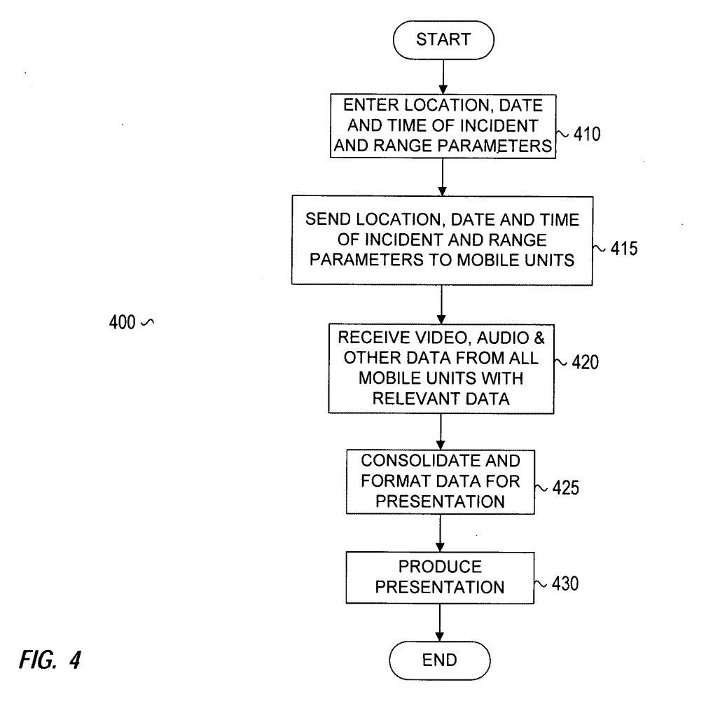

FIG. 4 shows a simplified flow diagram for a process of using the distributed surveillance system as described above. The flow diagram illustrated in FIG. 4 is from the point-of-view of the central collection point (shown as 300 in FIG. 3). In FIG. 4, the location, date and time of the incident, and the range parameters for gathering evidence, are entered in step 410. The location of the incident may be entered as a terrestrial coordinate (latitude, longitude), as a street address, or graphically entered as a point on a computer displayed map. If the location is entered in any form other than a terrestrial coordinate, the location may be translated to a terrestrial coordinate by a method well-known to those skilled in the art. The range parameters may include both a spatial and temporal range. For example, a radius around the point of the incident and time periods before and after the approximate time of the incident. The suitably processed location of the incident, the date and time of the incident, and range parameters may be sent to one or more mobile units in step 415. Mobile units with relevant information respond by sending such information back to the central collection point. The video, audio, and other data is received in step 420. Relevant data from all mobile units is consolidated and formatted for presentation in step 425. The presentation is produced in step 430. As discussed above, the presentation may be made on a visual display (335 in FIG. 3) or may be prepared in some form of hard-copy (paper, CD-ROM, DVD, etc.).

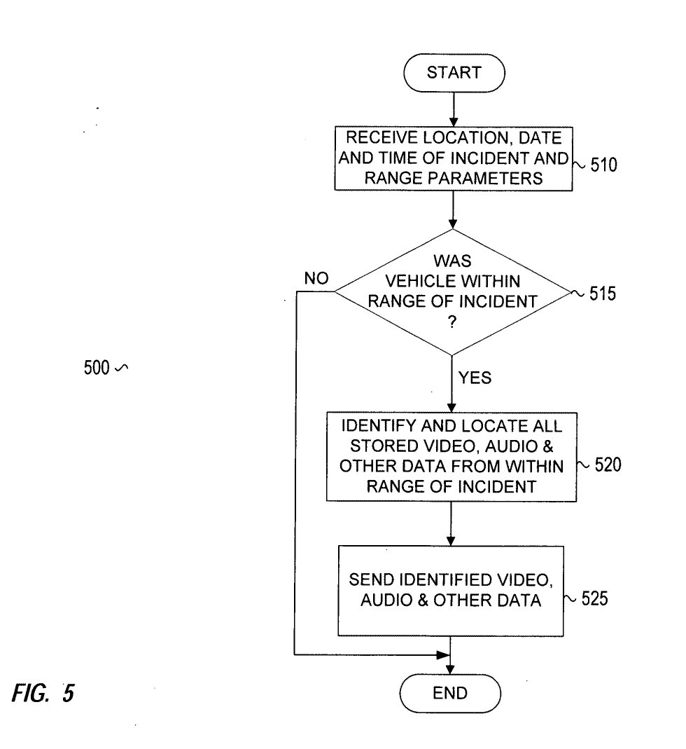

FIG. 5 shows a simplified flow diagram for a process carried out in the one or more on-vehicle acquisition, storage and communication systems (illustrated as 200 in FIG. 2). In FIG. 5, the location, date and time of the incident, and the range parameters are received in step 510. The location and time of the incident, along with the range parameters may be used in step 515 to determine if the associated vehicle was in the area of the incident within the time period indicated. If the vehicle was in the appropriate area in the designated time period, the process, in step 520, identifies and locates all stored data from within the range of the incident. The identified data is sent to the central collection point in step 525. If, in step 515, the vehicle was not in the appropriate location in the appropriate time period, the process ends without transmitting any information to the central collection point.

The many features and advantages of the invention are apparent from the detailed specification. Thus, the appended claims are intended to cover all such features and advantages of the invention which fall within the true spirits and scope of the invention. Further, since numerous modifications and variations will readily occur to those skilled in the art, it is not desired to limit the invention to the exact construction and operation illustrated and described. Accordingly, all appropriate modifications and equivalents may be included within the scope of the invention.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A distributed mobile surveillance system comprising:
one or more on-vehicle acquisition, storage and communication systems for acquiring, storing and transmitting video information; and
a central collection and processing point electrically connectable to the one or more on-vehicle acquisition, storage and communication systems for collecting and processing the video information acquired by the one or more on-vehicle acquisition, storage and communication systems.

2. A method for use of a distributed mobile surveillance system, the method comprising:
entering a location, time and date of an incident;
sending the entered location, time and date of the incident to one or more on-vehicle acquisition, storage and communication systems;
receiving video data recorded at or near the location, time and date of the incident by the one or more on-vehicle acquisition, storage and communication systems;
consolidating the received video data; and
creating a presentation of the consolidated video data.

3. The method of claim 2, wherein the entering step additionally comprises the entering of a range of locations and a range of time.
